(19) United States
(12) Patent Application Publication
(10) Pub. No.: US 2008/0270915 A1
(43) Pub. Date: Oct. 30, 2008

(54) Community-Based Security Information Generator

(76) Inventors: Avadis Tevanian, Los Altos Hills, CA (US); Mark Stevans, Sunnyvale, CA (US); William Charles Hankinson, Mountain View, CA (US)

Correspondence Address: J. NICHOLAS GROSS, ATTORNEY, 2030 ADDISON ST., SUITE 610, BERKELEY, CA, 94704, US

(21) Appl. No.: 12/112,613

(22) Filed: Apr. 30, 2008

Related U.S. Application Data
(60) Provisional application No. 60/914,913, filed on Apr. 30, 2007.

(51) Int. Cl. G06F 3/048; G06F 17/30; G06F 15/16

(52) U.S. Cl. 715/751; 707/10; 715/763; 707/E17.032

(57) ABSTRACT

An enhanced wiki function is included for an Internet based community associated with financial markets. Shared resource objects created by members, as well as other content, can be integrated by a wiki editor—including with WYSIWYG functionality—into Wiki pages for ease of information dissemination.

### RELATED APPLICATION DATA

The present application claims the benefit under 35 U.S.C. 119(e) of the priority date of Provisional Application Ser. No. 60/914,913 filed Apr. 30, 2007, which is hereby incorporated by reference. The present application also expressly incorporates by reference U.S. application Ser. No. 11/753,128 titled Online Community-Based Vote Security Performance Predictor filed May 24, 2007 and Ser. No. 12/021,031 titled Graphical Prediction Editor filed Jan. 28, 2008.

### FIELD OF THE INVENTION

The present invention relates to electronic methods of collecting, facilitating and compiling content from online users concerning the performance and/or time-behavior of items. The invention has particular applicability to so-called Wiki type pages and collaborative environments in which members can contribute, share and dynamically update content related to a security (or other time varying asset).

### BACKGROUND

Many methods currently exist for the creation and display of online information for securities but they lack the ability to collect information from an online community in a structured way. Prior methods are either limited to aggregation of various facts from various sources (e.g., a price/earnings ratio or a past growth rate) or an aggregation of opinions from various pre-selected sources of opinions (e.g., buy/sell ratings from security analysts), or even simply a collection of individual postings (as in the case of message boards). When opinions are aggregated they are further limited by the aggregation criteria, e.g., a price target, rather than any form of unstructured opinions (e.g., new product introductions should increase sales). Information may be aggregated in a typical text, graphics and media presentation. Time coded information may be further integrated into related graphs with time coding including not only the past but the future.

Other prior art systems (in some non-financial applications at least) have allowed for the collection of information from a community of users. For example, the online encyclopedia, Wikipedia.org, allows a community of users to create edit and maintain a very large collection of information on virtually any topic. As an encyclopedia, its goal is to provide factually accurate information on various topics. The community maintains correctness essentially by peer review. When one member finds an error, he simply edits it and provides the correct information. While debates about factuality can occur, over a short period of time the community will find the correct information and update the entry accordingly. Similarly, a wiki is defined basically as a collection of web pages designed to enable anyone who accesses it to contribute or modify content, using a simplified markup language. Wikis are often used to create collaborative websites and to power community websites.

Wiki pages have become popular as a way for a community of users to quickly share information in a very unstructured way. The content is controlled by all of the members and is largely unconstrained.

The simplified markup language used to create wikis is known as “wikitext”. The style and syntax of wikitexts can vary greatly among wiki implementations. Generally speaking Wiki editors only allow for very plain text editing, but some allow HTML tags, and there is an interest in attempting to integrate more “WYSIWYG” (“What You See Is What You Get”) capability. Typically this can be done using a JavaScript or an ActiveX control that translates graphically entered formatting instructions, such as “bold” and “italics”, into corresponding HTML tags or wikitext. However, WYSIWYG controls to date have been limited, and do not always provide all of the features available in wikitext.

In the case of information on securities there is a large benefit of introducing some structure as well as allowing for the aggregation of free-form opinions, including cases where facts simply are not known and multiple views can be presented together. For example, a simple structure might include parts that are fact-based and others that are opinion-based. The fact-based part might include information that is publicly verifiable with the community forming a consensus in a model similar to Wikipedia.org. The opinion-based part might allow for competing opinions to be collected and displayed simultaneously, e.g. a “bull” case and a “bear” case. Aggregating both types of information together into one concise location allows a user wishing to learn more about the security to have a single location to view all relevant information available.

To assist such functionality it would be desirable to include some additional editing capability into a standard Wiki editor to allow for and accommodate for the unique requirements of financial based applications. In this way, the sharing of information can be better optimized for such environments.

### SUMMARY OF THE INVENTION

A main object of the present invention, therefore, is to reduce and/or eliminate the deficiencies of the aforementioned prior art systems.

A first specific object concerns a method of presenting information to an online community. This method may comprise a combination of any one or more of the following steps:

providing a first topic which includes a first content made available for both review and content contributions by members of the online community;

providing at least one web page which is adapted for presenting the first content to the online community and collecting opinions and contributions of content concerning the topic from the online community;

wherein the web page includes at least:

a first portion associated with collecting and presenting opinions concerning the topic posted by the members of the online community;

a second portion associated with collecting and presenting facts concerning the topic posted by the members of the online community;

and further wherein both the first portion and the second portion are editable by at least some selected members of the online community such that the first content is revisable by the members of the online community;

the topic is a security, a commodity or other publicly traded investment;
selected members are selected by reference to meeting a length of membership criterion and/or a trust criterion;
the first portion and second portions present the opinions and content in a non-linear form;
the proposed changes to the first content are first quarantined or sequestered for review by the selected members prior to modifying the first content;
the proposed changes are identified to the online community for consideration and review;
the entire online community is permitted to vote on an opinion on whether to include the proposed changes;
information posted in the second portion is given an identifier to define its status as factual information;
facts posted in the second portion are correlated with a date associated with one or more events;
events and dates are overlaid on a chart associated with the topic; the chart is a graphical price-time chart for a security, commodity, or other financial instrument;
information posted in the first portion is organized and sorted such that more recent opinions are identified first;
opinions older than a predetermined time are identified with a time status indicator;
changes to the opinions are identified with a change status indicator and optional time stamp.

A further aspect of the invention concerns a method of generating a Wiki web page. This method may comprise a combination of any one or more of the following steps:

providing a first type of content within a Wiki portion of a web page that can be altered manually by at least some members of an online community;
providing a second type of content within the Wiki portion of the web page that is updated in response to an automated variable data source;
the second type of content is a resource object shared by a plurality of Wiki web pages;
the resource object is updated automatically by a computer software routine;
the resource object is updated manually by a human editor;
changes to the resource object are imported and/or propagated automatically to the plurality of Wiki web pages;
the resource object is automatically configured with a format suitable to each of the plurality of Wiki web pages;
the resource object is graphical data uploaded by a member of the online community;
the resource object includes a number of identifying tags;
the resource object is structured data within a table provided by a member of the online community;
the second type of content is updated based on a page refresh;
the resource object is a semi-automated data source comprising a subsection or slice of an automated data source selected by a human editor;

Another aspect of the invention also concerns a method of generating a Wiki web page. This method may comprise a combination of any one or more of the following steps:

providing one or more shared electronic resource objects accessible within the Wiki page, the shared resource objects including tags which can be associated with one or more separate Wiki pages;
processing an updated version of at least a first one of the one or more shared electronic resource objects;
providing an update routine configured to automatically render the updated version of the at least first one of the one or more shared resource objects to selected ones of the one more separate Wiki pages;
the tags are generated automatically based on content of the shared resource object;
at least some of the one or more separate Wiki pages are automatically updated in response to changes made to the one or more shared resource objects;
other steps as noted above for other aspects of the invention can be employed as well in other embodiments.
Still a further aspect of the invention also concerns a method of generating a Wiki web page. This method may comprise a combination of any one or more of the following steps:
providing a WYSIWYG (What You See Is What You Get) editor for editing content on the Wiki web page;
providing one or more shared resource objects accessible within the WYSIWYG editor, the shared resource objects including tags which can be associated with one or more first Wiki pages;
wherein changes to the one or more shared resource objects can be propagated automatically to selected ones of the first Wiki pages.
the WYSIWYG editor providing a second type of content on the Wiki web page that is updated dynamically by a data source;
the WYSIWYG editor includes features and/or functions that can be selectively varied and enabled based on a context under which the editor is invoked;
the context relates to a content of the Wiki web page, such that a first set of features/functions are enabled for a first class of content, and a second different set of features/functions are enabled for a second different class of content; the context relates to a status of a user invoking the editor, such that a first set of features/functions are enabled for a first class of user, and a second different set of features/functions are enabled for a second different class of user;
the context relates to both a content of the Wiki web page and a status of a user invoking the editor; other steps as noted above for other aspects of the invention can be employed as well in other embodiments.

Another aspect of the invention also concerns a method of generating content for a Wiki web page. This method may comprise a combination of any one or more of the following steps:

providing a shared electronic resource object including at least shareable data and one or more tags;
integrating the shared resource object within a Wiki editor which is configured to create wiki content for a plurality of separate Wiki web pages;
wherein the shared electronic resource object can be associated with a selected group of the plurality of separate Wiki web pages based on selecting the one or more tags and embedding the shared electronic resource object within a wiki content portion of the respective selected group of pages;
   propagating and/or importing the shareable data to the selected group of pages so that data is shared and updated dynamically for viewers of the pages; other steps as noted above for other aspects of the invention can be employed as well in other embodiments.

Other aspects of the invention are directed to systems and hardware which are configured with suitable software routines so that the above methods can be implemented and enjoyed by members over a network connection, preferably the Internet.

It will be understood from the Detailed Description that the inventions can be implemented in a multitude of different embodiments. Furthermore, it will be readily appreciated by skilled artisans that such different embodiments will likely include only one or more of the aforementioned objects of the present inventions. Thus, the absence of one or more of such characteristics in any particular embodiment should not be construed as limiting the scope of the present inventions. Moreover while described in the context of an equities price prediction system, it will be apparent to those skilled in the art that the present teachings could be used in any Internet based application that can benefit from a community prediction of some form for an item.

### DESCRIPTION OF THE DRAWINGS

FIG. 1 is simplified block diagram of the general processes used in a preferred embodiment of the invention;

FIG. 2 is an illustration of a preferred time-based graph (in this case, a stock price history graph) annotated with relevant ranked information providing a viewer the opportunity to see how certain information relates to the underlying topic based on time;

FIG. 3 depicts a preferred embodiment of a Wiki type page for a financial application that can be presented within a graphical interface to members of an online community;

FIG. 4 depicts a preferred embodiment of a Wiki type editor used to create the aforementioned wiki-type page of FIG. 3;

FIG. 5 depicts a preferred embodiment of a resource object upload/creation page which is adapted for increasing the capability of Wiki pages, including the Wiki page of FIG. 3;

FIGS. 6A and 6B depict a preferred embodiment of a resource object tool which is adapted for creating Figures, Tables, and other shareable resources within Wiki pages, including the Wiki page of FIG. 3;

FIG. 7 shows a flowchart of a preferred wiki page creation process of the present invention.

### DETAILED DESCRIPTION

Unlike unstructured wiki pages, the present invention provides sufficient structure for the information to be valuable in the case of evaluating information about securities. In this way, a user can count on viewing the information about a security and being able to understand the factual data and to also know that opinions are aggregated and can be evaluated in that context. Wiki pages that are too unstructured make it possible that the information available about any one security versus another is so disparate that it becomes useless.

Weblogs, or blogs, have become a common mechanism for people to express opinions about various topics and when comments or feedback are allowed they provide a mechanism to collect information and opinions about various topics. However, blogs are largely uneditable, certainly not by community members. They therefore provide no ability for peer review making the quality of the information suspect. Further, blogs with comments are linear in nature providing no free-form mechanism to collect, organize or analyze information.

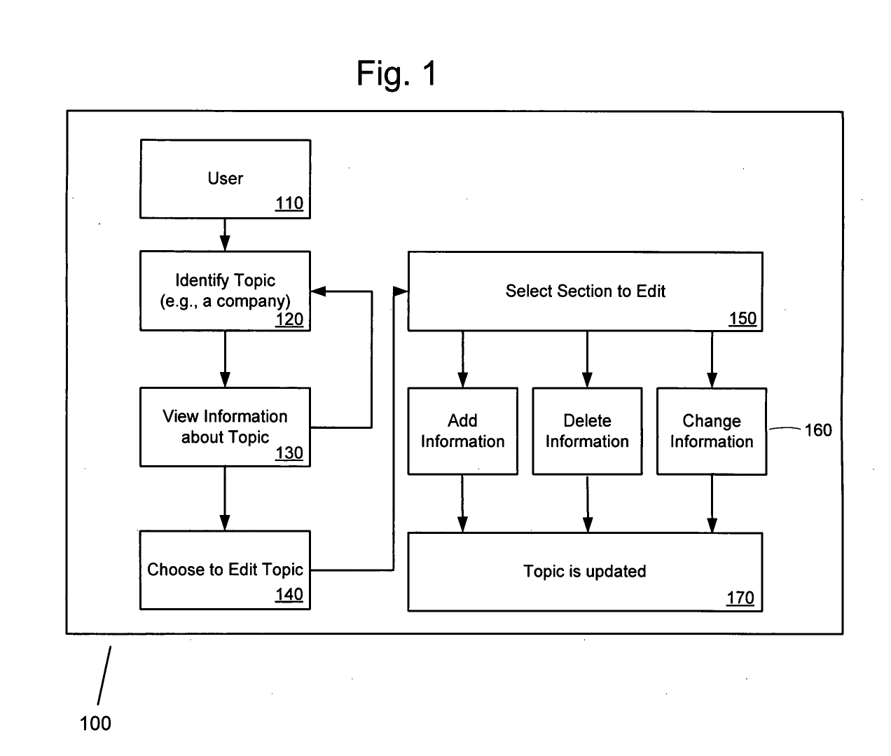

A simplified block diagram of the general components, steps and inputs/outputs used in a preferred embodiment of the invention is shown in FIG. 1. In a preferred embodiment of this invention members would be authorized to become part of a community. In some instances admission criteria or posting criteria may be desirable in some communities. In a preferred embodiment this community has responsibility for the information collected about stocks or other securities. It will be apparent that the type of information collected will be a function of the particular community, and the invention is not limited in this respect. Therefore the same approach could be used for commentary/analysis of other topics besides stocks.

Thus, as shown in FIG. 1, a user 110 (preferably a member) is allowed to identify a topic at step 120. The user can then view the information/content about the topic at 130 as is done in any other conventional wiki-like application. At 140 the user then can choose a topic to edit. As seen, the user can also select portions or sections of the content to edit at 150. For example a user may elect to only contribute/edit comments dealing with a company's products, or earnings, or management, etc. Other examples will be apparent to those skilled in the art depending on the particular application.

During step 160 the user can then elect to add, delete, or alter information about the topic as part of an ongoing collaborative process. These changes are then updated at step 170.

The above processes are known generally in the art for Wiki-pages, but have not been implemented in a financial site application. Moreover the present invention enhances these conventional operations with additional features as discussed herein.

For example, it is preferable that only members of the community (or some subset permitted to post at least) would determine and enter factual information (so flagged) and peer review would maintain the integrity of the data (e.g., earnings information, shares outstanding, management team, etc.). Again in many instances it may be desirable to restrict the membership in peer review to members satisfying certain criteria or thresholds, such as a length of membership, popularity, performance, a trust score or other appropriate factors. This type of factual information is already generally available in several forms from several data providers; however, in the present invention the community of users determines which data is collected and how it is presented to other users. With the community in control the data presentation is significantly improved over other systems that rely on mechanisms such as automated data feeds and automatic data presentation styles.

Further, at step 160 members of the community can add their own opinions (e.g., “I think this stock is undervalued because . . . ”) as well. Opinions would optionally be labeled in a relevant way, for example a “bull” opinion, a “bear” opinion, or just an opinion—to distinguish them from entries intended to communicate only factual content.

As part of the updating process 170, the community preferably uses peer review (along the lines as explained earlier) to completely eliminate irrelevant opinions. Similarly, the community would optionally respond to opinions and could agree or disagree while specifying reasons. Such updates to opinion data can be made by any approved editor (not shown).

Of course fact based information and opinion based information can be freely integrated as editors see fit. Information that has some relevancy to a certain time, e.g., a product announcement date or an earnings release, may be tagged with date data. Further, the actual relevancy of each piece of information can be evaluated or rated by the community. Such “rankings” can affect how the data is presented to other users (e.g., ordering or other visual indications like color in a graphical depiction).

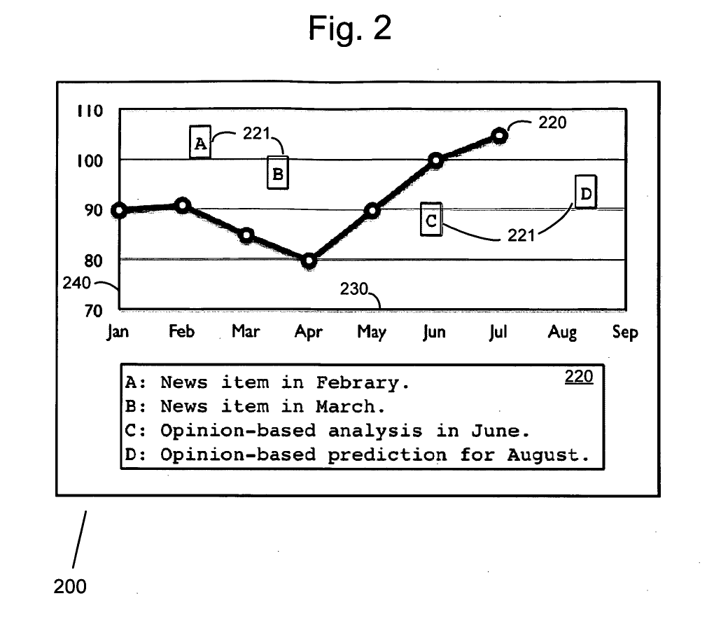

In the case of data that is time coded additional display opportunities are possible so that wiki-type information can be integrated into a conventional time/price graph. For example, as seen in FIG. 2, time-based graphs 200 (e.g., a stock price history graph) viewable within an interface at a conventional financial website can be annotated with the most relevantly ranked information providing a viewer the opportunity to see how certain information 210—provided by the wiki entries of the members as entries 221—relates to the underlying topic performance on axis 240 as a function of time 230. Since the data may contain information tagged with future dates (e.g., a prediction of a future event), the graphs may contain annotations that extend into the future. This can provide insights into the future behavior of the underlying security.

Since opinions can change over time, each security's information can be edited to reflect these changes. Most wikis handle changes of information by overwriting the prior information with the new information. In a preferred embodiment of this invention the system would allow old opinions to continue to be published but marked as an outdated opinion—updated by a new one—tagged by an appropriate date and/or reason. Similarly, the change of information in and of itself is a new form of information and can be represented as such, including having a time coding (the date of the change).

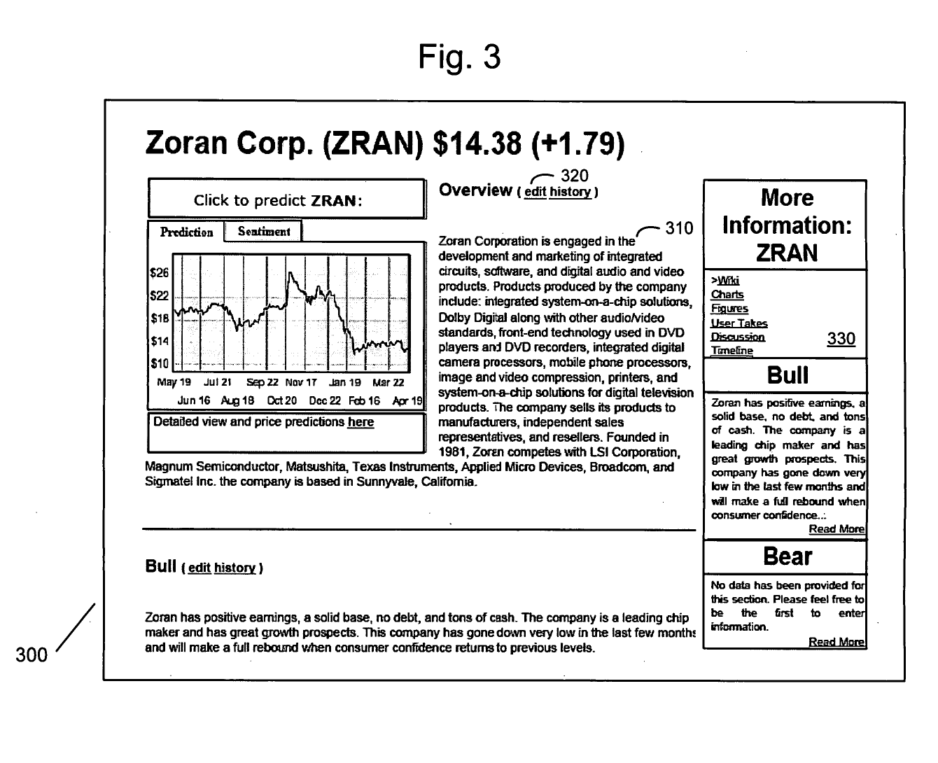

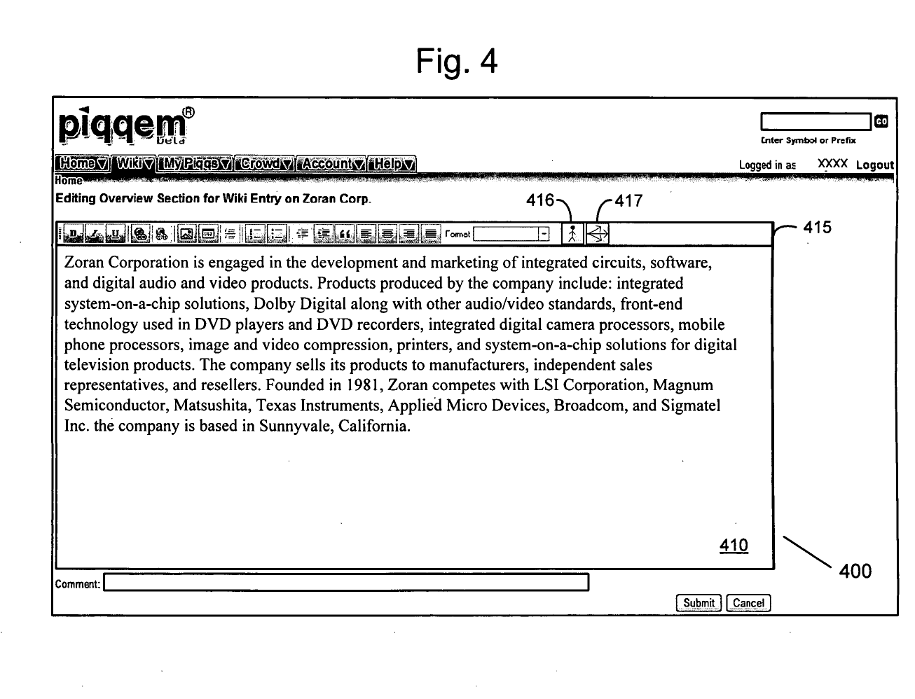

A more detailed preferred embodiment of a Wiki type page 300 for a financial application that can be presented within a graphical interface to members of an online community is shown in FIG. 3. In this wiki page 300 there are a number of key components, including basically a content/information section 310, which, as noted above, is provided by a collective and collaborative process by contributors to a financial website. The information for an entry or topic can be edited through selecting one or more links 320 on the page in conventional fashion. This edit link 320 causes an enhanced WYSIWYG wiki editor to become active for the user as is shown in more detail below in connection with FIG. 4. A section 330 of the interface in FIG. 3 provides additional control functions that are also explained further below, including the incorporation of new charts and figures options that are unique to the present invention.

FIG. 4 depicts a preferred embodiment of a Wiki type editor 400 used to create the aforementioned wiki-type page 300 of FIG. 3. The editor provides a content area 410 in which information for the topic (in this case a stock, ZRAN) can be visualized in a WYSIWYG format. A toolbar 415 provides for conventional formatting functions, such as altering font appearances, adjusting margins, embedding outline/bullet notations, embedding URLs and other graphical data.

At least one of the buttons 416 on toolbar 415 allows for live, dynamically computed data from a designated source to be integrated into the wiki. Any designated source with data that changes over time can be used. For example, the source could be as simple as a stock quote (updated whenever the page is generated on each page view) or it could be something like the crowd sentiment for a stock as generated by one of the inventions described in the aforementioned Ser. No. 11/753,128 and Ser. No. 12/021,031 applications described earlier. Other types of data which are generated and entered within a dedicated portion of the wiki page could be used as well, including the same types of sources (sports scores, weather, news items) used for so-called gadgets of the type offered by Google. Other examples appropriate to different applications will be apparent to those skilled in the art.

In lieu or in addition to such designated source data, a semi-automated data source could also be used. For example a user-chosen slice of an automated data source could also be embedded within the wiki page. As a specific example in a financial application, a user could, within a suitably configured browser, elect to save a particular view of a page as an automagically updating figure. Another instance where this feature could be useful is in “group” wiki pages. For example, if a user creates a group that's focused on 25 tech stocks, it would be useful to create some sort of “Portfolio” table (with predictions, outlooks, etc) which the user can embed on the group wiki “home” page or a subpage if desired. Other types of groups and excerpts/slices could be use of course, and other examples will be apparent to those skilled in the art for other applications.

Another button 417 on toolbar 415 can be used for incorporating and bringing in tagged images contributed by members. These images are tagged by members, so that a creator of a wiki page on a particular topic can easily identify potentially relevant graphical content. This allows the ability to add to a wiki (regardless of the editor) a shared resource like a figure that when updated on one page is automatically seen in updated form on other wiki pages.

Another optional feature which can be incorporated into embodiments of the present invention is the use of a different classes of editors (preferably a WYSIWYG editor) which show different features/functions to members in different contexts. In other words a first class of editor might be used for one type of wiki pages, with a first level of features/functions. A second editor class, with enhanced features might be used for other types of wiki pages, depending on the content and/or privileges afforded to the user in question. Other parameters could be considered as well in determining the functionality to be imparted in a particular context. Thus, for example in a financial application/website, a first type of wiki editor could be used for equity pages and a separate one for generic wiki pages. Each could have its own separate basic template. Group wikis could be a separate class as well with their own separate custom setup. In this manner it is feasible that different versions would have their own plugins/modifications to make them even more distinct.

Different editors could also be created or presented within each class to a user based on further classifying user permissions/rights. For example, if someone's “role” or status within the community was “novice editor” they may only get bold/italic/underline privileges suitable for identifying info to be corrected. Other classes of users with different status may be entitled to add or actually implement the proposed corrections. For example a “guru” might be given all access/editing privileges. As they become more trustworthy and/or achieve higher levels or status within the community, the functionality of the editor they're presented with could expand correspondingly. The number and types of classes of editors and users can be varied of course depending on the application involved.

While some wikis allow for links to be embedded, this aspect of the present invention is different because it allows for a live link or a graphical data source that is used for purposes of generating the actual page. The software routine required for implementing such feature within a Wiki page can be implemented in any conventional fashion known in the art, including by a Java based routine, an AJAX based routine, or some other software which can output a markup language format useable by a wiki rendering engine.

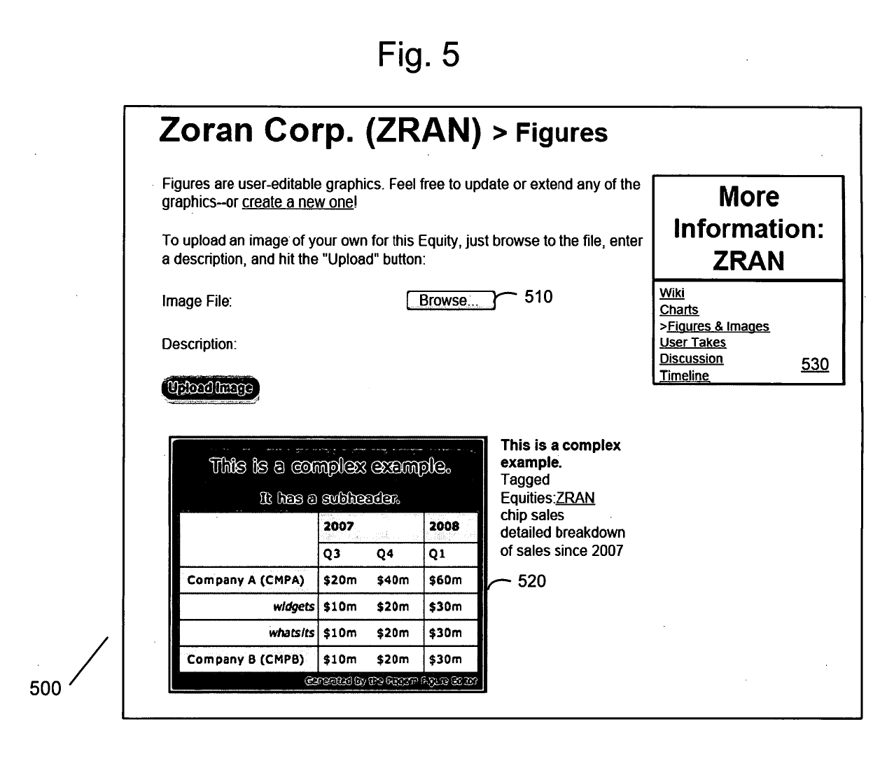

FIG. 5 depicts a preferred embodiment of a resource object upload/creation page 500 which is adapted for increasing the capability of Wiki pages, including the Wiki page of FIG. 3. As seen in FIG. 5, users are permitted to upload images (or other content of their choosing) directly to the wiki page in question. This can be used to enhance the appearance and utility of the Wiki through incorporation of other user-contributed multi-media content. At section 520 of the interface, users are permitted to create new types of structured data sources in the form of tables and other formatted data. Section 530 of the interface includes a standard link for selecting this aspect of the invention.

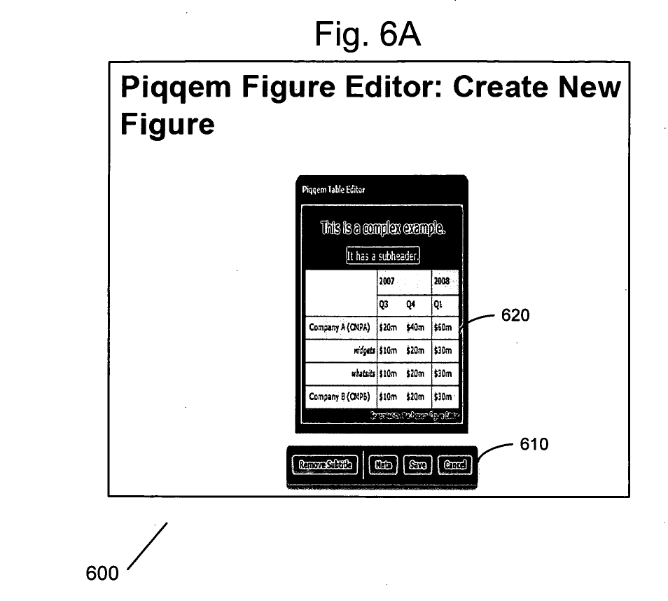

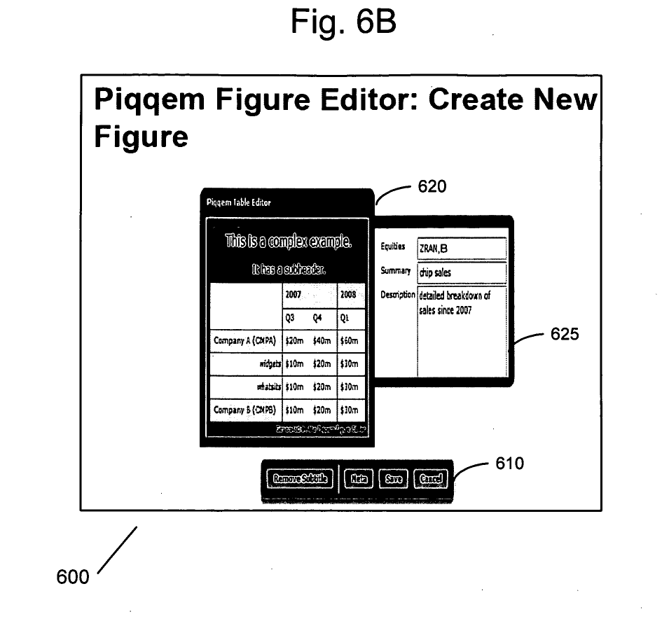

FIGS. 6A and 6B depict a preferred embodiment of a resource object tool which is adapted for creating Figures, Tables, and other shareable resources within Wiki pages, including the Wiki page of FIG. 3. This screen is activated when a member selects a figure from section 520 of interface 500. As seen in FIG. 6A, a figure editor 600 allows for creating structure, shared resource data within a wiki. A toolbar 610 includes a number of buttons for changing or saving the content, title or metadata of a table 620. The table can include a number of configurable columns and rows for displaying data. As an example, the table can show the quarterly sales of widgets for one or more companies.

At FIG. 6B, an additional metadata editing feature allows a figure author/creator to include tags (or other descriptors) to indicate which equities the figure is to be associated with. In this instance for example the tag is identified as ZRAN, but other tags could be used as well (such as for a competitor, company B). In some cases an automated tool may be used to supplement a member's input and create additional relevant tags based on an analysis of the content or image data.

Now that the graphical data has been created, this allows other wiki page editors, when viewing entries for ZRAN and Company B, to bring up editor 400 you import any images tagged with such labels. Thus, an editor for ZRAN or company B can bring the table of FIG. 6A right in-line with the rest of the text of the page. In this manner, common graphical image data can be viewed as a shared resource for multiple wiki pages.

As time passes, any data changes can be passed seamlessly and dynamically to any wiki page incorporating the shared graphical resource object. For example, in 3 months, when there is another quarter of data, the creator of the structure data figure would simply update this table to reflect the new sales data. That's all this is required. Thus, a reference to the actual object is kept in the wiki page; thereafter, whenever a user requests that wiki page it is rendered correctly dynamically, or on the fly. While somewhat less efficient, it may be desirable in some cases to push or propagate the changes automatically to other wiki pages incorporating the figure. Under either scenario, the next time a member views the ZRAN or company B wiki page, they would see the up-to-date figure.

Furthermore the invention can allow the data capture and presentation t to be de-coupled. So, as seen in FIG. 6A, as one uses figure editor 600 one must only put in row/column names, titles, and data. The “look” of the table can be generated automatically and customized by the user as desired for a particular application. Moreover the appearance of the figure can be changed on the fly to accommodate the format and context of each individual wiki page on which it appears.

In contrast to the present invention, a traditional wiki would only allow the user put in arbitrary HTML links to try to duplicate the above functionality. However this is cumbersome because one must create a destination for that link somewhere, create the content, link it in, etc. Thus the present invention avoids reliance on HTML alone. Moreover one is also more limited in how such content will appear in the wiki page, and in many cases is even limited to only displaying a clickable link.

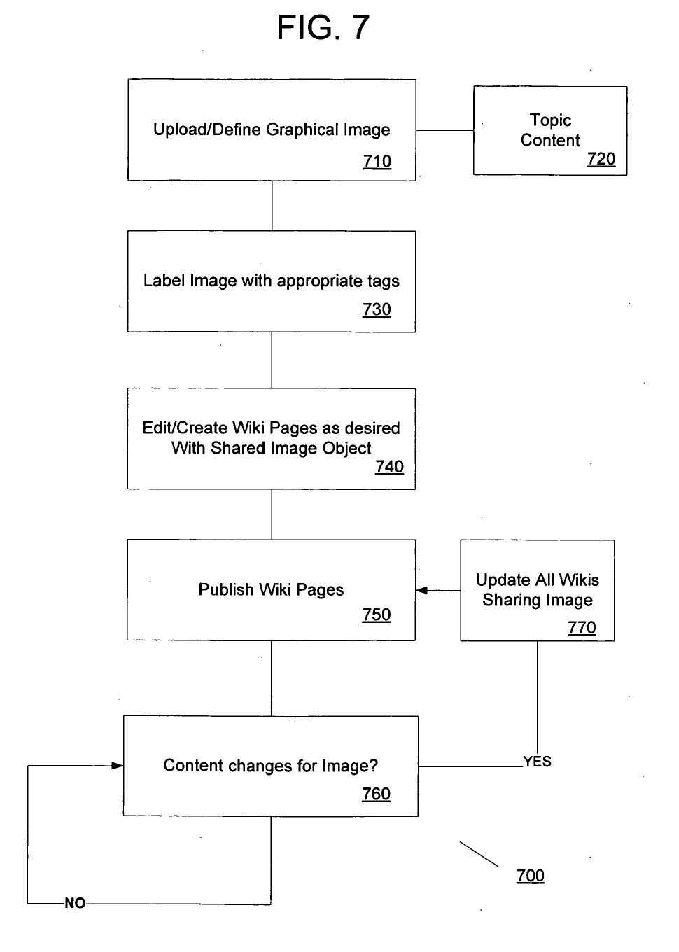

FIG. 7 shows a flowchart of the general wiki page creation process 700 that can be implemented by one on more software routines to implement the wiki shared graphics resource features of the present invention. At step 710, a user (preferably a member) uploads or defines a Graphical Image as noted above, which, as described, can be any form of multimedia data, or a structured data form such as a table. The member can also associate particular content (i.e. raw data for sales or other figures as needed) at step 720 with each element or field of the structured data. At step 730 the user (or some other automated tool) associates the image with appropriate tags or labels as explained above, and the image can also be provided automatically with appropriate and preferably unique identification data for later use by other routines.

At various times other members can then invoke a wiki editor 400 at step 740 (see FIG. 4) to import the various shared resource objects, including an image generated at steps 710-730. Thus during step 740 a number of different wiki pages may be associated with a particular unique image, each being related in most cases to a page by a member using a tag identified with the image in question. In some instances an automated routine may be employed to automatically disseminate/propagate an image to one or more wiki pages having common tags with the image.

Step 750 then results in the various edited wiki pages being published for perusal and editing by other members, as noted earlier in connection with FIG. 1. At step 760 a human editor of the image, or an electronic routine in some cases, can then input updated information relating to data within the image, including text, graphics, etc.

Upon detecting such change, another software routine at step 770 automatically updates all appropriate wiki pages referencing the image in question. As noted earlier, this updated information may, in some cases, result not only in a change in the actual content, but also in a change in the format of the image as presented within a wiki page. For example, adding another quarter's worth of sales data may be automatically incorporated as another column within a sales data shared image object. Other examples will be apparent to those skilled in the art from the present teachings.

It will be understood that the invention is not limited to any particular hardware implementation in this respect, and that such components can be implemented preferably by one or more software routines and databases executing (or residing) on a combination of hardware platforms, including conventional Internet servers. Some aspects of the invention may be implemented in part on client side devices, such as a personal computer, a cellphone, PDA, consumer electronic device, etc. Again those skilled in the art will appreciate that the particular hardware is not critical to the operation of the invention.

The above descriptions are intended as merely illustrative embodiments of the proposed inventions. It is understood that the protection afforded the present invention also comprehends and extends to embodiments different from those above, but which fall within the scope of the present claims.

What is claimed is:

1. A method of presenting information to an online community comprising:
providing a first topic which includes a first content made available for both review and content contributions by members of the online community;
providing at least one web page which is adapted for presenting said first content to said online community and collecting opinions and contributions of content concerning said topic from said online community;
wherein said web page includes at least:
a first portion associated with collecting and presenting opinions concerning said topic posted by said members of the online community;
a second portion associated with collecting and presenting facts concerning said topic posted by said members of the online community;
and further wherein both said first portion and said second portion are editable by at least some selected members of said online community such that said first content is revisable by said members of said online community.

2. The method of claim 1, wherein said topic is a security, a commodity or other publicly traded investment.

3. The method of claim 1 wherein said selected members are selected by reference to meeting a length of membership criterion.

4. The method of claim 1 wherein said selected members are selected by reference to meeting a trust criterion.

5. The method of claim 1 wherein said first portion and second portions present said opinions and content in a non-linear form.

6. The method of claim 1 wherein proposed changes to said first content are first quarantined or sequestered for review by said selected members prior to modifying said first content.

7. The method of claim 6, wherein said proposed changes are identified to said online community for consideration and review.

8. The method of claim 7 wherein said entire online community is permitted to vote on an opinion on whether to include said proposed changes.

9. The method of claim 1, wherein information posted in said second portion is given an identifier to define its status as factual information.

10. The method of claim 1, where said facts posted in said second portion are correlated with a date associated with one or more events.

11. The method of claim 10, wherein said events and dates are overlaid on a chart associated with said topic.

12. The method of claim 11, wherein said chart is a graphical price-time chart for a security, commodity, or other financial instrument.

13. The method of claim 1, wherein information posted in said first portion is organized and sorted such that more recent opinions are identified first.

14. The method of claim 13, wherein opinions older than a predetermined time are identified with a time status indicator.

15. The method of claim 13, wherein changes to said opinions are identified with a change status indicator and optional time stamp.

16. A method of generating a Wiki web page comprising:
a. providing a first type of content within a Wiki portion of a web page that can be altered manually by at least some members of an online community;
b. providing a second type of content within the Wiki portion of the web page that is updated in response to an automated variable data source.

17. The method of claim 16 wherein said second type of content is a resource object shared by a plurality of Wiki web pages.

18. The method of claim 16 wherein said resource object is updated automatically by a computer software routine.

19. The method of claim 17 wherein said resource object is updated manually by a human editor.

20. The method of claim 17 wherein changes to said resource object are propagated automatically to said plurality of Wiki web pages.

21. The method of claim 17 wherein said resource object is automatically configured with a format suitable to each of said plurality of Wiki web pages.

22. The method of claim 16 wherein said resource object is graphical data uploaded by a member of the online community.

23. The method of claim 22 wherein said resource object includes a number of identifying tags.

24. The method of claim 16 wherein said resource object is structured data within a table provided by a member of the online community.

25. The method of claim 16 wherein said second type of content is updated based on a page refresh.

26. The method of claim 17 wherein said resource object is a semi-automated data source comprising a subsection or slice of an automated data source selected by a human editor.

27. A method of generating a Wiki page comprising:
a. providing one or more shared electronic resource objects accessible within said Wiki page, said shared resource objects including tags which can be associated with one or more separate Wiki pages;
b. processing an updated version of at least a first one of said one or more shared electronic resource objects;
c. providing an update routine configured to automatically render said updated version of said at least first one of said one or more shared resource objects to selected ones of said one more separate Wiki pages.

28. The method of claim 27 wherein said tags are generated automatically based on content of said shared resource object.

29. The method of claim 27 wherein at least some of said one or more separate Wiki pages are automatically updated in response to changes made to said one or more shared resource objects.

30. A method of generating a Wiki page comprising:
a. providing a WYSIWYG (What You See Is What You Get) editor for editing content on the Wiki web page;
b. providing one or more shared resource objects accessible within said WYSIWYG editor, said shared resource objects including tags which can be associated with one or more first Wiki pages;
wherein changes to said one or more shared resource objects can be propagated and/or imported automatically to selected ones of said first Wiki pages.
c. said WYSIWYG editor providing a second type of content on the Wiki web page that is updated dynamically by a data source.

31. The method of claim 30 wherein WYSIWYG editor includes features and/or functions that can be selectively varied and enabled based on a context under which said editor is invoked.

32. The method of claim 31 wherein said context relates to a content of said Wiki web page, such that a first set of features/functions are enabled for a first class of content, and a second different set of features/functions are enabled for a second different class of content.

33. The method of claim 31 wherein said context relates to a status of a user invoking said editor, such that a first set of features/functions are enabled for a first class of user, and a second different set of features/functions are enabled for a second different class of user.

34. The method of claim 31 wherein said context relates to both a content of said Wiki web page and a status of a user invoking said editor, such that a first set of features/functions can be enabled for a first class of user editing a first type of content, and a second different set of features/functions can be enabled as needed for a second different class of user editing a second type of content.

35. A method of generating content for a Wiki page comprising:
a. providing a shared electronic resource object including at least shareable data and one or more tags;
b. integrating said shared resource object within a Wiki editor which is configured to create wiki content for a plurality of separate Wiki web pages;
wherein said shared electronic resource object can be associated with a selected group of said plurality of separate Wiki web pages based on selecting said one or more tags and embedding said shared electronic resource object within a wiki content portion of said respective selected group of pages;
c. propagating and/or importing said shareable data to said selected group of pages so that data is shared and updated dynamically for viewers of said pages.

36. A system for presenting information to an online community comprising:
one or more software routines executing on a server computing device and which are configured:
to provide a first topic which includes a first content made available for both review and content contributions by members of the online community;
to provide at least one web page which is adapted for presenting said first content to said online community and collecting opinions and contributions of content concerning said topic from said online community;
wherein said web page includes at least:
a first portion associated with collecting and presenting opinions concerning said topic posted by said members of the online community;
a second portion associated with collecting and presenting facts concerning said topic posted by said members of the online community;
and further wherein both said first portion and said second portion are editable by at least some selected members of said online community such that said first content is revisable by said members of said online community.

37. A system for generating a Wiki web page comprising:
one or more software routines executing on a server computing device and which are configured:
a. to provide a first type of content within a Wiki portion of a web page that can be altered manually by at least some members of an online community;
b. to provide a second type of content within the Wiki portion of the web page that is updated in response to an automated variable data source.

38. A system for generating a Wiki page comprising:
one or more software routines executing on a server computing device and which are configured:
a. to provide one or more shared electronic resource objects accessible within said Wiki page, said shared resource objects including tags which can be associated with one or more separate Wiki pages;
b. to automatically update selected ones of said one more separate
Wiki pages in response to changes made to said one or more shared resource objects.

39. A system for generating a Wiki page comprising:
one or more software routines executing on a server computing device and which are configured:
a. to provide a WYSIWYG (What You See Is What You Get) editor for editing content on the Wiki web page;
b. to provide one or more shared resource objects accessible within said WYSIWYG editor, said shared resource objects including tags which can be associated with one or more first Wiki pages;
wherein changes to said one or more shared resource objects can be propagated and/or imported automatically to selected ones of said first Wiki pages.
c. said WYSIWYG editor providing a second type of content on the Wiki web page that is updated dynamically by a data source.

40. A system for generating content for a Wiki page comprising:
one or more software routines executing on a server computing device and which are configured:
a. to provide a shared electronic resource object including at least shareable data and one or more tags;
b. to integrate said shared resource object within a Wiki editor which is configured to create wiki content for a plurality of separate Wiki web pages;
wherein said shared electronic resource object can be associated with a selected group of said plurality of separate Wiki web pages based on selecting said one or more tags and embedding said shared electronic resource object within a wiki content portion of said respective selected group of pages;
c. to propagate and/or import said shareable data to said selected group of pages so that data is shared and updated dynamically for viewers of said pages.
